(19) United States
(12) Patent Application Publication
(10) Pub. No.: US 2025/0230282 A1
(43) Pub. Date: Jul. 17, 2025

(54) MANUFACTURING METHOD OF POLYIMIDE POWDER AND POLYIMIDE POWDER MANUFACTURED BY THE SAME

(71) Applicant: PI Advanced Materials Co., Ltd., Chungcheongbuk-do (KR)

(72) Inventors: Hosung Lee, Chungcheongbuk (KR); Minseok Yang, Jeollanam-do (KR); Iksang Lee, Chungcheongbuk (KR)

(21) Appl. No.: 18/853,102

(22) PCT Filed: Apr. 7, 2023
(86) PCT No.: PCT/KR2023/004760

§ 371 Date: Sep. 30, 2024

(30) Foreign Application Priority Data
Apr. 11, 2022 (KR) 10-2022-0044668

(51) Int. Cl. C08G 73/10; C08L 79/08

(52) U.S. Cl. CPC C08G 73/1042; C08G 73/1032; C08G 73/1071; C08L 79/08

(57) ABSTRACT

Provided are a manufacturing method of polyimide powder capable of promoting imidization and having excellent intrinsic viscosity by controlling a polymerization reaction using a mixed solvent comprising a polar organic solvent and a high-boiling aromatic hydrocarbon solvent, and polyimide powder manufactured by the same.

### TECHNICAL FIELD

The following disclosure relates to a manufacturing method of polyimide powder and polyimide powder manufactured by the same, and more specifically, to a manufacturing method of polyimide powder using a mixed solvent containing a polar organic solvent and an aromatic hydrocarbon solvent having a high-boiling point, and polyimide powder manufactured by the same.

### BACKGROUND ART

According to the development of advanced technology, high heat-resistant polymer materials such as polyimide, and the like, are essential materials for small size and lightweight, high performance, and high reliability of products, and used in a wide range of industries such as space, aviation, electric/electronic, automobile, precision equipment, and the like, in the form of films, moldings, fibers, paints, adhesives and composites, and the like. Polyimide has excellent mechanical strength, chemical resistance, weather resistance and heat resistance based on chemical stability of the imide ring. In addition, polyimide has advantages of the ease of synthesis, the possibility of manufacturing into thin films, and not requiring a crosslinking group for curing, and is in the limelight as a high-functional polymer material in various fields from microelectronics to optics, and the like, due to excellent electrical properties.

Recently, lightweight and small size of products have been considered important in the display field, but currently used glass substrates have disadvantages in that they are heavy, brittle, and have difficulties in continuous processing. For this reason, a polyimide substrate having the advantage of being lightweight, flexible, and capable of continuous processing has been manufactured as a substitute for glass substrates, and may also be used even when forming insulating films and protective coating agents for semiconductor devices, surface protection materials and base resins for flexible circuit boards and integrated circuits, and furthermore, interlayer insulating films and protective films for fine circuits. In particular, when used as a coating material, a protective material in which molded bodies such as polyimide films are adhered with an adhesive, or a liquid polyimide resin solution, or the like, may be used.

In a general method for synthesizing polyimide, a polyamic acid, which is a precursor, is first synthesized by a reaction between dianhydride acid and diamine, and then the polyamic acid is imidized. The polyamic acid synthesis is to manufacture a polyamic acid by ring-opening and polyaddition reactions between diamine and dianhydride dissolved in a solvent. At this time, the reaction solvent used is mainly a polar organic solvent. Polyimide is manufactured by imidizing the synthesized polyamic acid through dehydration and ring closure reaction using chemical or thermal methods.

The chemical imidization method is a method in which a chemical dehydrating agent represented by an acid anhydride such as acetic anhydride, or the like, and an imidization catalyst represented by tertiary amines such as pyridine, and the like, are added to a polyamic acid solution as a precursor.

When the imidization reaction is performed by additionally adding the dehydrating agent or the catalyst as described above, there is a problem in that productivity and process efficiency are low due to the price of the catalyst and the need for an additional process to remove the catalyst.

Meanwhile, the thermal imidization method is performed by applying a polyamic acid solution as a precursor to a substrate, evaporating the solvent, and heating at 250 to 350° C. without the chemical dehydrating agent and the catalyst. However, this method has disadvantages in that the degree of crystallinity is high and the polymer is decomposed due to an amide exchange reaction when an amide-based solvent is used.

In the polyimide powder manufactured by these methods, if the degree of imidization is low, there is a problem in that water, which is a by-product of the imidization reaction, is generated during processing, thereby creating pores and reducing mechanical properties, resulting in deterioration of physical properties.

Therefore, it is necessary to research and develop polyimide powder having excellent intrinsic viscosity while promoting imidization through a simple and efficient process without the addition of a separate dehydrating agent or catalyst, and a manufacturing method of polyimide powder capable of manufacturing molded articles having excellent tensile strength and elongation.

### DISCLOSURE OF INVENTION

### Technical Problem

An embodiment of the present disclosure is directed to providing a manufacturing method of polyimide powder capable of promoting imidization and having excellent intrinsic viscosity through a reaction using a mixed solvent containing a polar organic solvent and a high-boiling hydrogen hydrocarbon solvent without adding a separate dehydrating agent or catalyst, and polyimide powder manufactured by the same.

In addition, another embodiment of the present disclosure is directed to providing a manufacturing method of a molded article containing the polyimide powder.

Further, still another embodiment of the present disclosure is directed to providing a molded article containing the polyimide powder.

### Solution to Problem

Hereinafter, exemplary embodiments of the disclosure will be described in more detail in the order of “manufacturing method of polyimide powder”, “polyimide powder”, “manufacturing method of a molded article containing polyimide powder”, and “a molded article containing polyimide powder” according to the present disclosure.

Since various changes can be made and various embodiments can be provided in the present disclosure, specific exemplary embodiments are illustrated in the drawings and described in detail. However, it should be understood that this is not intended to limit the present disclosure to specific embodiments, and comprises all modifications, equivalents, and substitutes included in the spirit and scope of the present disclosure.

Terms used in the present application are only used to describe specific exemplary embodiments, and are not intended to limit the present disclosure. Singular expressions include plural expressions unless the context clearly indicates otherwise. In the present specification, terms such as “comprise” or “have” are intended to designate the presence of features, numbers, steps, operations, components, parts, or combinations thereof described in the specification and they should not be understood as precluding the possibility of the presence or addition of one or more other features, numbers, steps, operations, components, parts, or combinations thereof.

When an amount, concentration, or other value or parameter in the present specification is provided as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed.

Where a range of numerical values is recited herein, unless otherwise stated, it is not intended that the range be limited to the endpoints and the scope of the disclosure be limited to the specific values recited when defining a range.

As used herein, term “dianhydride” is intended to include precursors or derivatives thereof, also referred to as “dianhydride” or “acid dianhydride”. It may not technically be dianhydride, but may nevertheless react with diamine to form a polyamic acid, which may be converted back to polyimide.

“Diamine” as used herein is intended to include precursors or derivatives thereof, which may not technically be diamine, but may nonetheless react with dianhydride acid to form a polyamic acid, which may be converted back to polyimide.

Further, unless defined otherwise, all terms used herein, including technical or scientific terms, have the same meaning as commonly understood by one of ordinary skill in the art to which the embodiments belong. Terms such as those defined in commonly used dictionaries should be interpreted as having a meaning consistent with the meaning in the context of the related art. Unless explicitly defined in the present application, it is not to be construed in an ideal or overly formal sense. Specific details for the implementation of the disclosure will be described below.

The present disclosure provides a manufacturing method of polyimide powder using a mixed solvent containing a polar organic solvent and a high-boiling aromatic hydrocarbon solvent having a boiling point of 155° C. or higher.

In an aspect, the manufacturing method of polyimide powder according to the present disclosure may comprise:
(a) preparing a polyamic acid composition by dispersing a dianhydride compound and a diamine compound in a mixed solvent; and
(b) imidizing the mixture at high temperature to form polyimide powder,
wherein the mixed solvent comprises a polar organic solvent and a high-boiling aromatic hydrocarbon solvent having a boiling point of 155° C. or higher.

In the present disclosure, the polar organic solvent may have a boiling point of 150° C. or higher, preferably 160° C. or higher, more preferably 170° C. or higher, and still more preferably 200° C. or higher, wherein the upper limit is not specifically limited, but may be 250° C. or less.

In the present disclosure, the polar organic solvent may be N,N-dimethylformamide (DMF), N,N-dimethylacetamide (DMAC), N-methyl-2-pyrrolidone (NMP), dimethyl sulfoxide (DMSO), ethylene glycol, N-ethyl-2-pyrrolidone (NEP), dimethylolpropionic acid (DMPA), or a combination thereof, and the like, preferably Nmethyl-2-pyrrolidone (NMP).

The high-boiling aromatic hydrocarbon may have a boiling point of 160° C. or higher, preferably 160 to 250° C. The lower limit of the boiling point may be, for example, 160° C. or higher, 161° C. or higher, 162° C. or higher, 163° C. or higher, 164° C. or higher, or 165° C. or higher. Further, the upper limit of the boiling point of the high-boiling aromatic hydrocarbon may be, for example, 250° C. or less, 245° C. or less, 240° C. or less, 235° C. or less, 230° C. or less, 225° C. or less, 220° C. or less, 215° C. or less, 210° C. or less, 205° C. or less, 200° C. or less, 198° C. or less, 196° C. or less, 194° C. or less, 192° C. or less, 190° C. or less, 188° C. or less, 186° C. or less, 184° C. or less, 182° C. or less, or 180° C. or less.

In the present disclosure, the high-boiling aromatic hydrocarbon may be mesitylene, 1,2,4-trimethylbenzene, 1,2,3-trimethylbenzene, propylbenzene, 1-ethyl-2-methylbenzene, and the like, preferably 1,2,4-trimethylbenzene, 1,2,3-trimethylbenzene, propylbenzene, 1-ethyl-2-methylbenzene or a combination thereof.

In the present disclosure, the mixed solvent may further comprise a hydrocarbonbased solvent, and the hydrocarbon-based solvent may be hexane, cyclohexane, heptane, benzene, toluene, isopropylene, xylene, or a combination thereof, preferably may comprise isopropylene or xylene, but the scope of the hydrocarbon-based solvent of the present disclosure is not limited thereto.

In the present disclosure, based on 100 parts by weight of the mixed solvent, the high-boiling aromatic hydrocarbon solvent may be contained in an amount of 5 to 50 parts by weight, specifically 10 to 45 parts by weight, more specifically 15 to 40 parts by weight, and even more specifically, 20 to 35 parts by weight, and the remaining amount may be accounted for by the polar organic solvent or hydrocarbon-based solvent.

In the present disclosure, based on 100 parts by weight of the mixed solvent, the polar organic solvent may be contained in an amount of 50 to 95 parts by weight, specifically 55 to 90 parts by weight, more specifically 60 to 85 parts by weight, and even more specifically, 65 to 80 parts by weight, and the remaining amount may be accounted for by the aromatic hydrocarbon solvent or hydrocarbon-based solvent.

In addition, the mixed solvent of the present disclosure may contain 50 to 95 parts by weight of the polar organic solvent and 5 to 50 parts by weight of the high-boiling aromatic hydrocarbon solvent, and may further contain 1 to 5 parts by weight of the hydrocarbon-based solvent.

In the present disclosure, the polyimide powder may be fully aromatic polyimide, partially alicyclic polyimide, and fully alicyclic polyimide.

In an embodiment of the present disclosure, the dianhydride compound may be pyromellitic dianhydride (PMDA), oxydiphthalic dianhydride (ODPA), 3,3′,4,4′-biphenyltetracarboxylic dianhydride (sBPDA), 2,3,3′,4′-biphenyltetracarboxylic dianhydride (a-BPDA), diphenylsulfone-3,4,3′,4′-tetracarboxylic dianhydride (DSDA), bis(3,4-dicarboxyphenyl)sulfide dianhydride, 2,2-bis(3,4-dicarboxyphenyl)-1,1,1,3,3,3-hexafluoropropane dianhydride, 2,3,3′,4′-benzophenonetetracarboxylic dianhydride, 3,3′,4,4′-benzophenonetetracarboxylic dianhydride (BTDA), bis(3,4-dicarboxyphenyl) methane dianhydride, 2,2-bis(3,4-dicarboxyphenyl) propane dianhydride, p-phenylenebis(trimellitic monoester acid anhydride), pbiphenylenebis(trimellitic monoester acid anhydride), mterphenyl-3,4,3′,4′-tetracarboxylic dianhydride, p-terphenyl-3,4,3′,4′-tetracarboxylic dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy) biphenyl dianhydride, 2,2-bis[(3,4-dicarboxyphenoxy)phenyl]propane dianhydride (BPADA), 2,3,6,7-naphthalene tetracarboxylic acid dianhydride, 1,4,5,8-naphthalenetetracarboxylic dianhydride, and 4,4′-(2,2-hexafluoroisopropylidene)diphthalic acid dianhydride, and preferably, may be pyromellitic dianhydride (PMDA), oxydiphthalic dianhydride (ODPA), or a combination thereof. The range of the dianhydride compound of the present disclosure is not limited thereto, and dianhydride used in the manufacture of polyimide may be widely used.

In addition, the diamine compound may be paraphenylenediamine, metaphenylenediamine, 3,3′-dimethylbenzidine, 2,2′-dimethylbenzidine, 2,4-diaminotoluene, 2,6-diaminotoluene, 3,5-diaminobenzoic acid (DABA), 4,4′-diaminodiphenylether, 4,4′-oxydianiline (ODA), 3,4′-diaminodiphenylether, 4,4′-diaminodiphenylmethane(methylenediamine), 3,3′-dimethyl-4,4′-diaminobiphenyl, 2,2′-dimethyl-4,4′-diaminobiphenyl, 2,2′-bis(trifluoromethyl)-4,4′-diaminobiphenyl, 3,3′-dimethyl-4,4′-diaminodiphenylmethane, 3,3′-dicarboxy-4,4′-diaminodiphenylmethane, 3,3′,5,5′-tetramethyl-4,4′-diaminodiphenylmethane, bis(4-aminophenyl) sulfide, 4,4′-diaminobenzanilide, 3,3′-dimethoxybenzidine, 2,2′-dimethoxybenzidine, 3,3′-diaminodiphenylether, 3,4′-diaminodiphenylether, 4,4′-diaminodiphenylether, 3,3′-diaminodiphenylsulfide, 3,4′-diaminodiphenylsulfide, 4,4′-diaminodiphenylsulfide, 3,3′-diaminodiphenylsulfone, 3,4′-diaminodiphenylsulfone, 4,4′-diaminodiphenylsulfone, 3,3′-diaminobenzophenone, 4,4′-diaminobenzophenone, 3,3′-diamino-4,4′-dichlorobenzophenone, 3,3′-diamino-4,4′-dimethoxybenzophenone, 3,3′-diaminodiphenylmethane, 3,4′-diaminodiphenylmethane, 4,4′-diaminodiphenylmethane, 2,2-bis(3-aminophenyl)propane, 2,2-bis(4-aminophenyl)propane, 2,2-bis(3-aminophenyl)-1,1,1,3,3,3-hexafluoropropane, 2,2-bis(4-aminophenyl)-1,1,1,3,3,3-hexafluoropropane, 3,3′-diaminodiphenylsulfoxide, 3,4′-diaminodiphenylsulfoxide, 4,4′-diaminodiphenylsulfoxide, 1,3-bis(3-aminophenyl)benzene, 1,3-bis(4-aminophenyl)benzene, 1,4-bis(3-aminophenyl)benzene, 1,4-bis(4-aminophenyl)benzene, 1,3-bis(4-aminophenoxy)benzene (TPE-R), 1,4-bis(3-aminophenoxy)benzene (TPE-Q), 1,3-bis(3-aminophenoxy)-4-trifluoromethylbenzene, 3,3′-diamino-4-(4-phenyl)phenoxybenzophenone, 3,3′-diamino-4,4′-di(4-phenylphenoxy)benzophenone, 1,3-bis(3-aminophenylsulfide)benzene, 1,3-bis(4-aminophenylsulfide)benzene, 1,4-bis(4-aminophenylsulfide)benzene, 1,3-bis(3-aminophenylsulfone)benzene, 1,3-bis(4-aminophenylsulfone)benzene, 1,4-bis(4-aminophenylsulfone)benzene, 1,3-bis[2-(4-aminophenyl)isopropyl]benzene, 1,4-bis[2-(3-aminophenyl)isopropyl]benzene, 1,4-bis[2-(4-aminophenyl)isopropyl]benzene, 3,3′-bis(3-aminophenoxy) biphenyl, 3,3′-bis(4-aminophenoxy) biphenyl, 4,4′-bis(3-aminophenoxy) biphenyl, 4,4′-bis(4-aminophenoxy) biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, bis[3-(3-aminophenoxy)phenyl]ketone, bis[3-(4-aminophenoxy)phenyl]ketone, bis[4-(3-aminophenoxy)phenyl]ketone, bis[4-(4-aminophenoxy)phenyl]ketone, bis[3-(3-aminophenoxy)phenyl]sulfide, bis[3-(4-aminophenoxy)phenyl]sulfide, bis[4-(3-aminophenoxy)phenyl]sulfide, bis[4-(4-aminophenoxy)phenyl]sulfide, bis[3-(3-aminophenoxy))phenyl]sulfone, bis[3-(4-aminophenoxy)phenyl]sulfone, bis[4-(3-aminophenoxy)phenyl]sulfone, bis[4-(4-aminophenoxy)phenyl]sulfone, bis[3-(3-aminophenoxy)phenyl]methane, bis[3-(4-aminophenoxy)phenyl]methane, bis[4-(3-aminophenoxy)phenyl]methane, bis[4-(4-aminophenoxy)phenyl]methane, 2,2-bis[3-(3-aminophenoxy)phenyl]propane, 2,2-bis[3-(4-aminophenoxy)phenyl]propane, 2,2-bis[4-(3-amino) phenoxy)phenyl]propane, 2,2-bis[4-(4-aminophenoxy)phenyl]propane (BAPP), 2,2-bis[3-(3-aminophenoxy)phenyl]-1,1,1,3,3,3-hexafluoropropane, 2,2-bis[3-(4-aminophenoxy)phenyl]-1,1,1,3,3,3-hexafluoropropane, 2,2-bis[4-(3-aminophenoxy)phenyl]-1,1,1,3,3,3-hexafluoropropane, and 2,2-bis[4-(4-aminophenoxy)phenyl]-1,1,1,3,3,3-hexafluoropropane, and the like, and preferably, may be 4,4′-oxydianiline (ODA). The range of the diamine compound of the present disclosure is not limited thereto, and diamine compound used in the manufacture of polyimide may be widely used.

In an embodiment, the polyimide powder may be manufactured by using pyromellitic dianhydride (PMDA) and oxydiphthalic dianhydride (ODPA) as the dianhydride compound, and using 4,4′-oxydianiline (ODA) as the diamine compound.

In an embodiment, the polyamic acid composition may contain two or more types of dianhydride compounds, and among them, may contain pyromellitic dianhydride (PMDA). Specifically, the pyromellitic dianhydride (PMDA) may be contained in a ratio of 70 mol % or more of the total dianhydride components. The lower limit of the ratio may be, for example, 75 mol %, 78 mol %, 80 mol %, 82 mol %, 85 mol %, 87 mol %, 90 mol %, 92 mol %, 94 mol %, 95 mol %, 97 mol %, 99 mol %, or 100 mol % or more, and the upper limit thereof may be, for example, 100 mol %, 99 mol %, 98 mol %, 97 mol %, 96 mol %, 95 mol %, 94 mol %, 93 mol %, 92 mol %, 91 mol % or 90 mol % or less.

In an embodiment, the polyamic acid composition may comprise two or more types of dianhydride compounds, and among them, may comprise oxydiphthalic dianhydride (ODPA). Specifically, the oxydiphthalic dianhydride (ODPA) may be contained in a ratio of 30 mol % or less of the total dianhydride components. The ratio may preferably be 20 mol % or less, 19 mol % or less, 18 mol % or less, 17 mol % or less, 16 mol % or less, 15 mol % or less, 14 mol % or less, 13 mol % or less, 12 mol % or less, 11 mol % or less % or less, 10 mol % or less, 8 mol % or less, 6 mol % or less, 4 mol % or less, or 2 mol % or less, or may be 0 mol %.

In an embodiment, the polyamic acid composition may comprise at least one diamine compound, and preferably may comprise 4,4′-oxydianiline (ODA). Specifically, the 4,4′-oxydianiline (ODA) may be contained in a ratio of 70 mol % or more of the total diamine monomer components. The lower limit of the ratio may be, for example, 70 mol % or more, 71 mol % or more, 72 mol % or more, 73 mol % or more, 74 mol % or more, 75 mol % or more, 76 mol % or more, 77 mol % or more, 78 mol % or more, 80 mol % or more, 82 mol % or more, 85 mol % or more, 87 mol % or more, 90 mol % or more, 92 mol % or more, 94 mol % or more, 95 mol % or more, 97 mol % or more, 99 mol % or more, or 100 mol %, and the upper limit thereof may be, for example, 100 mol % or less, 99 mol % or less, 98 mol % or less, 97 mol % or less, 96 mol % or less, 95 mol % or less, 94 mol % or less, 93 mol % or less, 92 mol % or less, 91 mol % or less, or 90 mol % or less.

In the present disclosure, in Step (a), a molar ratio of the diamine compound to the dianhydride compound may be 0.5 to 2 equivalents. The molar ratio may be specifically 0.8 to 1.5 equivalents. When the molar ratio is less than 0.5 equivalent or more than 2 equivalents, the finally formed polyimide has a very small molecular weight, and accordingly, there is a problem in that physical and chemical properties of polyimide are very poor.

In addition, the mixture in Step (a) may comprise a polyamic acid formed by polymerization of the dianhydride compound and the diamine compound.

Further, Step (a) may be performed in various ways, for example, by dispersing each compound in a solvent (or mixed solvent) and then introducing each reactant into a reaction vessel, and as another method, may be performed by first introducing a solvent (or mixed solvent) into a reaction vessel and then introducing each compound thereinto. In addition, Step (a) may be performed by a method of first introducing each compound into the reaction vessel and then introducing a solvent (or mixed solvent) thereinto, or may be performed by a combination of the above-described methods.

In the present disclosure, the mixed solvent may be used in an amount of 5 to 50 times, 7 to 40 times, and 10 to 30 times the weight of the dianhydride compound which is the reactant, and the amount of the mixed solvent may be appropriately adjusted depending on the amount of the dianhydride compound and the diamine compound used in the reaction.

Meanwhile, Step (a) may be performed in a temperature range of 10 to 95° C. When the temperature is less than 10° C., the reaction may not proceed, and when the temperature is more than 95° C., a separate additional heat source supply or cooling condenser, or the like, may be needed or additional processes may be required.

In addition, Step (a) may be performed for 5 minutes to 5 days, and specifically, may be performed for 1 hour to 2 days. When Step (a) is performed for less than 5 minutes, there may be a problem in that the reaction does not proceed sufficiently, and when Step (a) is performed for more than 5 days, there may be a problem in that the cost according to the process increases excessively.

In the present disclosure, Step (b) may be performed at a high temperature in the temperature range of 150 to 450° C. Specifically, Step (b) may be performed within a temperature range of 180 to 350° C. When Step (b) is performed at a temperature of less than 150° C., imidization may not proceed, and when Step (b) is performed at a temperature of more than 450° C., thermal decomposition of the monomer (or compound) or polymer itself may occur.

In the present disclosure, Step (b) may be performed for 5 minutes to 5 days, specifically for 10 minutes to 2 days, more specifically for 30 minutes to 1 day, and even more specifically for 1 hour to 5 hours. When Step (b) is performed for less than 5 minutes, imidization may not be performed, and when performed for more than 5 days, hydrolysis or thermal decomposition of the polymer may occur.

Meanwhile, in Step (b), the heating may be performed by one or a combination of two or more selected from the group consisting of heat treatment, hot air treatment, corona treatment, high frequency treatment, ultraviolet treatment, infrared treatment, and laser treatment.

In Step (b), the solid content of the polyimide powder is 1 to 25% by weight, specifically 1 to 20% by weight, more specifically 2 to 18% by weight, and more specifically 3 to 15% by weight.

Further, the manufacturing method of the polyimide powder of the present disclosure may further comprise (c) washing, filtering, and drying the polyimide powder.

The filtration may be performed by one or a combination of two or more selected from the group consisting of gravity filtration, reduced pressure filtration, vacuum filtration, pressure filtration, compression filtration, centrifugal filtration, micro filtration, ultrafiltration, and reverse osmosis method. In particular, the reduced pressure filtration may be preferably applied.

In addition, the drying may be performed by one or a combination of two or more selected from the group consisting of natural drying, pressure drying, hot air drying, spray drying, film drying, vacuum drying, freeze drying, spray freeze drying, electromagnetic wave drying, and flash drying methods. In particular, the drying may be preferably performed at 50° C. or higher under vacuum.

In the present disclosure, the imidization reaction performed in Step (b) may have an imidization rate of 97 to 100%, preferably 98 to 100%, more preferably 99 to 100%, and most preferably 100%.

In the manufacturing method of polyimide powder according to the present disclosure, as the imidization reaction is performed in the mixed solvent comprising the polar organic solvent and the high-boiling aromatic hydrocarbon solvent having a boiling point of 155° C. or higher, the high-boiling aromatic hydrocarbon solvent may simultaneously serve as a dehydrating agent to promote the imidization of polyamic acid without additionally adding a separate catalyst or dehydrating agent. In addition, since the powder is precipitated through imidization at a temperature of about 150 to 160° C., it is possible to perform sufficient imidization to maintain excellent physical properties such as improved intrinsic viscosity, and the like.

In another aspect, the present disclosure provides polyimide powder manufactured according to the manufacturing method of polyimide powder.

The polyimide powder has a high intrinsic viscosity of 1.0 dL/g or more, and thus has an advantage in that post-processing such as molding is easily performed while maintaining excellent mechanical properties.

In an embodiment, the intrinsic viscosity of the polyimide powder of the present disclosure may be 1.0 to 1.5 dL/g, specifically 1.0 to 1.3 dL/g, more preferably 1.0 to 1.2 dL/g, and even more preferably 1.1 to 1.15 dL/g. When the intrinsic viscosity of the polyimide powder is less than 1.0 dL/g, there is a problem in that the strength of a molded article (or molded body) molded from polyimide powder is weakened, and post-work is not easy.

In still another aspect of the present disclosure, the present disclosure provides a manufacturing method of a polyimide molded article comprising: (1) molding polyimide powder manufactured according to the manufacturing method of polyimide powder as described above; and (2) sintering.

In the molding step in Step (1), compression molding, injection molding, blow molding, rotational molding, extrusion molding, thermoforming, slush molding, spinning, and the like, may be applied.

In still another aspect, the present disclosure provides a polyimide molded article manufactured according to the manufacturing method of a polyimide molded article.

In the present disclosure, the polyimide molded article may have a tensile strength of 85 MPa or more, preferably 90 MPa or more, more preferably 95 MPa or more, even more preferably 100 MPa or more, and even still more preferably 110 MPa or more, wherein the upper limit thereof is not particularly limited, but may be 200 MPa or less.

Further, the polyimide molded article may have an elongation of 7% or more, preferably an elongation of 8% or more, more preferably 9% or more, and still more preferably 10% or more, wherein the upper limit thereof is not particularly limited, but may be 40% or less, 30% or less or 20% or less.

Further, the polyimide molded article may have a modulus of 1.5 GPa or more, preferably 2.0 GPa or more, more preferably 2.5 GPa or more, and even more preferably 3.0 GPa or more.

In addition, the polyimide molded article may have a flexural strength of 150 MPa or more, preferably 155 MPa or more, more preferably 160 MPa or more, and even more preferably 170 MPa or more, wherein the upper limit thereof is not particularly limited, but may be 300 MPa or less.

In the present disclosure, the molded article may be referred to as a molded body, and the manufactured molded article may be applied to a wide range of industries such as space, aviation, electric/electronic, semiconductor, display, liquid crystal alignment film, automobile, precision device, packaging, medical material, separator, fuel cell, secondary battery, and the like, in various forms such as film, adhesive, tape, fiber, multilayer film, and the like, and may be widely used in any product or field suitable for physical properties and characteristics of the molded article manufactured according to the polyimide powder of the present disclosure.

Further, the molded article comprising the polyimide powder manufactured according to the manufacturing method of polyimide powder according to the present disclosure has an advantage in that tensile strength, elongation, modulus, and flexural strength are all improved at the same time, thereby being able to be used in various fields requiring these physical properties.

### Advantageous Effects of Invention

A manufacturing method of polyimide powder according to the present disclosure promotes imidization by reacting in a mixed solvent comprising a polar organic solvent and a high-boiling aromatic hydrocarbon solvent without adding a separate dehydrating agent and catalyst, thereby making it possible to manufacture polyimide powder having high intrinsic viscosity and a high imidization rate through a simple and efficient process, and a molded article manufactured with the polyimide powder may have excellent tensile strength, elongation, modulus, and flexural strength.

### BEST MODE FOR CARRYING OUT THE INVENTION

The following Examples are presented to facilitate the understanding of the present disclosure. These Examples are only provided to more easily understand the present disclosure, but the content of the present disclosure is not limited by the following Examples.

### EXAMPLE

### Example 1. Manufacture of Polyimide Powder Using High-Boiling Aromatic Hydrocarbon Solvent

### Example 1-1. (1) Manufacture of Polyimide Powder

A polyamic acid composition was prepared by dispersing dianhydride compounds, i.e., pyromellitic dianhydride (PMDA) (80 mol %) and oxydiphthalic dianhydride (ODPA) (20 mol %), and a diamine compound, 4,4′-oxydianiline (100 mol %), in a mixed solvent in which N-methyl pyrrolidone, which is a polar solvent, and 1,2,3-trimethylbenzene (bp. 176° C.), which is a high-boiling aromatic hydrocarbon solvent, were mixed at a ratio of 70:30 (v/v %).

The mixture was transferred to a 500 mL reaction vessel equipped with a stirrer, a nitrogen injector, and a temperature controller, then the air in the reaction vessel was substituted with nitrogen gas, and the mixture was stirred in a high-temperature reactor at 180° C. for 6 hours to form polyimide powder.

The polyimide powder suspension was filtered under reduced pressure while washing with distilled water to thereby obtain an undried polyimide powder, followed by drying in a vacuum oven at 60° C. for 24 hours to obtain polyimide powder.

### Example 1-2. (2) Manufacture of Polyimide Powder

A mixture was prepared by dispersing dianhydride compounds, i.e., pyromellitic dianhydride (PMDA) (80 mol %) and oxydiphthalic dianhydride (ODPA) (20 mol %), and a diamine compound, 4,4′-oxydianiline (100 mol %), in a mixed solvent in which N-methyl pyrrolidone, which is a polar solvent, and 1,2,4-trimethylbenzene (bp. 169° C.), which is a high-boiling aromatic hydrocarbon solvent, were mixed at a ratio of 70:30 (v/v %).

The mixture was transferred to a 500 mL reaction vessel equipped with a stirrer, a nitrogen injector, and a temperature controller, the air in the reaction vessel was substituted with nitrogen gas, and the mixture was stirred in a high-temperature reactor at 180° C. for 6 hours to form polyimide powder.

The polyimide powder suspension was filtered under reduced pressure while washing with distilled water to thereby obtain an undried polyimide powder, followed by drying in a vacuum oven at 60° C. for 24 hours to obtain polyimide powder.

### Example 2. Manufacture of Molded Product of Polyimide Powder

### Example 2-1 and Example 2-2. Manufacture of Polyimide-Molded Product

The polyimide powder manufactured in Example 1-1 and Example 1-2 were weighed into molds for physical property evaluation, respectively, and heated up to a temperature of 450° C. while applying a pressure of 10,000 Psi or more with a hot press, thereby manufacturing molded products.

### Comparative Example 1. Manufacture of Polyimide Powder Using Low-Boiling Aromatic Hydrocarbon Solvent

### Comparative Example 1-1. Manufacture of Polyimide Powder

Polyimide powder was manufactured in the same manner as in Example 1, except that xylene (bp. 139° C.), a low-boiling aromatic hydrocarbon solvent, was used instead of the high-boiling aromatic hydrocarbon solvent.

### Comparative Example 1-2. Manufacture of Polyimide Powder

Polyimide powder was manufactured in the same manner as in Example 1, except that toluene (bp. 111° C.), a low-boiling aromatic hydrocarbon solvent, was used instead of the high-boiling aromatic hydrocarbon solvent.

### Comparative Example 1-3. Manufacture of Polyimide Powder

Polyimide powder was manufactured in the same manner as in Example 1 except for the high-boiling aromatic hydrocarbon.

### Comparative Example 2. Manufacture of Molded Product Employing Polyimide Powder Manufactured by Using Low-Boiling Aromatic Hydrocarbon Solvent

### Comparative Examples 2-1 to 2-3. Manufacture of Polyimide-Molded Product

The polyimide powder manufactured in Comparative Example 1-1 to Comparative Example 1-3 were weighed into molds for physical property evaluation, respectively, and heated up to a temperature of 450° C. while applying a pressure of 10,000 Psi or more with a hot press, thereby manufacturing molded products of Comparative Examples 2-1, 2-2 and 2-3, respectively.

Components and contents of the dianhydride compounds and the diamine compound and components of the mixed solvents used at the time of manufacturing the polyimide powder in Example 1-1, Example 1-2, Comparative Example 1-1, Comparative Example 1-2, and Comparative Example 1-3 above, respectively, are summarized in Table 1 below.

TABLE 1

| | | | | Comparative | Comparative | Comparative |
|---|---|---|---|---|---|---|
| | | | | Example | Example | Example |
| Component | | Example | Example | 1-1 | 1-2 | 1-3 |
| Dianhydride | PMDA | 80 mol % | 80 mol % | 80 mol % | 80 mol % | 80 mol % |
| compound | ODPA | 20 mol % | 20 mol % | 20 mol % | 20 mol % | 20 mol % |
| Diamine | ODA | 100 mol % | 100 mol % | 100 mol % | 100 mol % | 100 mol % |
| compound | | | | | | |
| Mixed | Polar organic | NMP | NMP | NMP | NMP | — |
| solvent | solvent | | | | | |
| | Aromatic | 1,2,3- | 1,2,4- | xylene | toluene | — |
| | hydrocarbon | trimethyl- | trimethyl- | | | |
| | | benzene | benzene | | | |

### <Experimental Examples> Analysis of Physicochemical Properties of Polyimide Powder and Molded Product

### Experimental Example 1. Imidization Rate

For the measurement of the imidization rate, the polyimide powder was manufactured into pellets, and then using a Nicolet iZ20 FT IR (ATR) from Thermo Fisher Scientific Inc., the imidization rate thereof was measured, compared, and calculated wherein the value of 1390 cm⁻¹/1490 cm⁻¹ was set as the 100% standard value of the polyimide film processed with 100% imidization.

### Experimental Example 2. Intrinsic Viscosity

The polyimide powder (0.1 g) manufactured according to Examples and Comparative Examples was dissolved in 20 ml of N,N′-dimethylacetamide, and the intrinsic viscosity thereof was measured with an Ubbelohde viscometer in a thermostat maintained at 30° C.

The imidization rate and intrinsic viscosity of the polyimide powder analyzed according to Experimental Examples 1 and 2 are shown in Table 2 below.

TABLE 2

| | | | Comparative | Comparative | Comparative |
|---|---|---|---|---|---|
| | Example 1-1 | Example 1-2 | Example 1-1 | Example 1-2 | Example 1-3 |
| Imidization | >100 | >100 | 95 | 96 | 90 |
| rate (%) | | | | | |
| Intrinsic | 1.12 | 1.11 | 0.95 | 0.93 | 0.86 |
| viscosity | | | | | |
| (dL/g) | | | | | |

### Experimental Example 3. Tensile Strength

The tensile strength of samples was measured with a universal testing machine (Instron 5564 manufactured by Instron Corp., Massachusetts, USA) as per ASTM D1708 standard.

### Experimental Example 4. Elongation

The elongation was measured on the polyimide molded bodies manufactured in Examples and Comparative Examples and cut into a width of 10 mm and a length of 40 mm, using Instron 5564 UTM equipment as per ASTM D-882 standard.

### Experimental Example 5. Flexural Strength

The flexural strength was measured with UTM as per ASTM D-882 standard.

Physical property results of the polyimide molded articles analyzed according to Experimental Examples 3 to 5 are shown in Table 3 below.

TABLE 3

| | | | Comparative | Comparative | Comparative |
|---|---|---|---|---|---|
| | Example | Example | Example | Example | Example |
| | 2-1 | 2-2 | 2-1 | 2-2 | 2-3 |
| Tensile strength (MPa) | 114 | 112 | 83 | 92 | 73 |
| Elongation (%) | 12 | 10 | 6.9 | 5.6 | 4.5 |
| Flexural strength (MPa) | 174 | 171 | 143 | 142 | 121 |

### Experimental Example 6. Modulus (Modulus of Elasticity)

Modulus of each polyimide molded body (15 mm in width) manufactured in Examples and Comparative Examples was measured with Instron 5564 UTM equipment as per ASTM D-882 standard (Grip Speed=200 mm/min).

The modulus of the polyimide molded article analyzed according to Experimental Example 6 is shown in Table 4 below.

TABLE 4

| | Example 2-1 | Example 2-2 |
|---|---|---|
| Modulus (GPa) | 2.3 | 2.2 |

Examples of the present disclosure in which the imidization reaction was performed using the high-boiling aromatic hydrocarbon solvent having a boiling point of 155° C. or higher achieved a high imidization rate of 100% and exhibited an excellent intrinsic viscosity of 1.0 dL/g or more. In addition, the molded articles manufactured using the polyimide powder according to the present disclosure had a tensile strength of 110 MPa or more, an elongation of 10% or more, and a flexural strength of 170 MPa or more, which were significantly superior to those of Comparative Examples. In addition, the molded article manufactured with the polyimide powder according to the present disclosure was found to have excellent rigidity since the modulus was 1.5 GPa or more. Comparative Examples 1-1 and 1-2 in which the imidization reaction was performed using the low-boiling aromatic hydrocarbon solvent of less than 155° C. and Comparative Example 1-3 in which the aromatic hydrocarbon solvent was not contained showed a lower imidization rate than that of Examples, and the molded articles of the polyimide powder manufactured according to Comparative Examples had significantly lower tensile strength, elongation, and flexural strength than those of Examples, which were not suitable for application to actual products.

In the present specification, the detailed description of the contents capable of being sufficiently recognized and inferred by those skilled in the art of the present disclosure are omitted, and many variations and modification can be made within a range that does not change the technical spirit or essential configuration of the present disclosure in addition to the specific exemplary embodiments described in the present specification. Therefore, the present disclosure may also be practiced in a manner different from that specifically described and illustrated herein, which can be understood by those skilled in the art.

1. A manufacturing method of polyimide powder comprising:
(a) preparing a polyamic acid composition by dispersing a dianhydride compound and a diamine compound in a mixed solvent; and
(b) imidizing the mixture at high temperature to form polyimide powder,
wherein the mixed solvent comprises a polar organic solvent and a high-boiling aromatic hydrocarbon solvent having a boiling point of 155° C. or higher.

2. The manufacturing method of claim 1, wherein the polar organic solvent has a boiling point of 150° C. or higher.

3. The manufacturing method of claim 1, wherein the polar organic solvent comprises at least one selected from the group consisting of N,N-dimethylformamide (DMF), N,N-dimethylacetamide (DMAC), N-methyl-2-pyrrolidone (NMP), dimethyl sulfoxide (DMSO), ethylene glycol, N-ethyl-2-pyrrolidone (NEP), and dimethylolpropionic acid (DMPA).

4. The manufacturing method of claim 1, wherein the high-boiling aromatic hydrocarbon solvent further comprises at least one selected from the group consisting of mesitylene, 1,2,4-trimethylbenzene, 1,2,3-trimethylbenzene, propylbenzene and 1-ethyl-2-methylbenzene.

5. The manufacturing method of claim 1, wherein the high-boiling aromatic hydrocarbon comprises a high-boiling aromatic hydrocarbon solvent having a boiling point of 160° C. or higher.

6. The manufacturing method of claim 1, wherein the mixed solvent further comprises a hydrocarbon-based solvent.

7. The manufacturing method of claim 6, wherein the hydrocarbon-based solvent comprises at least one selected from the group consisting of hexane, cyclohexane, heptane, benzene, toluene, isopropylene and xylene.

8. The manufacturing method of claim 1, wherein 50 to 95 parts by weight of the polar organic solvent and 5 to 50 parts by weight of the high-boiling aromatic hydrocarbon solvent are comprised based on 100 parts by weight of the mixed solvent.

9. The manufacturing method of claim 1, wherein the polyimide powder is any one selected from the group consisting of fully aromatic polyimide, partially alicyclic polyimide, and fully alicyclic polyimide.

10. The manufacturing method of claim 1, wherein the dianhydride compound is at least one selected from the group consisting of pyromellitic dianhydride (PMDA), oxydiphthalic dianhydride (ODPA), 3,3′,4,4′-biphenyltetracarboxylic dianhydride (sBPDA), 2,3,3′,4′-biphenyltetracarboxylic dianhydride (a-BPDA), diphenylsulfone-3,4,3′,4′-tetracarboxylic dianhydride (DSDA), bis(3,4-dicarboxyphenyl)sulfide dianhydride, 2,2-bis(3,4-dicarboxyphenyl)-1,1,1,3,3,3-hexafluoropropane dianhydride, 2,3,3′,4′-benzophenone tetracarboxylic dianhydride, 3,3′,4,4′-benzophenonetetracarboxylic dianhydride (BTDA), bis(3,4-dicarboxyphenyl) methane dianhydride, 2,2-bis(3,4-dicarboxyphenyl) propane dianhydride, pphenylenebis(trimellitic monoester acid anhydride), p-biphenylenebis(trimellitic monoester acid anhydride), m-terphenyl-3,4,3′,4′-tetracarboxylic dianhydride, p-terphenyl-3,4,3′,4′-tetracarboxylic dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy) biphenyl dianhydride, 2,2-bis[(3,4-dicarboxyphenoxy)phenyl]propane dianhydride (BPADA), 2,3,6,7-naphthalene tetracarboxylic acid dianhydride, 1,4,5,8-naphthalene tetracarboxylic dianhydride, and 4,4′-(2,2-hexafluoroisopropylidene)diphthalic acid dianhydride, and
the diamine compound is at least one selected from the group consisting of paraphenylenediamine, metaphenylenediamine, 3,3′-dimethylbenzidine, 2,2′-dimethylbenzidine, 2,4-diaminotoluene, 2,6-diaminotoluene, 3,5-diaminobenzoic acid (DABA), 4,4′-oxydianiline (ODA), 4,4′-diaminodiphenylether, 3,4′-diaminodiphenylether, 4,4′-diaminodiphenylmethane(methylenedianiline), 3,3′-dimethyl-4,4′-diaminobiphenyl, 2,2′-dimethyl-4,4′-diaminobiphenyl, 2,2′-bis(trifluoromethyl)-4,4′-diaminobiphenyl, 3,3′-dimethyl-4,4′-diaminodiphenylmethane, 3,3′-dicarboxy-4,4′-diaminodiphenylmethane, 3,3′,5,5′-tetramethyl-4,4′-diaminodiphenylmethane, bis(4-aminophenyl) sulfide, 4,4′-diaminobenzanilide, 3,3′-dimethoxybenzidine, 2,2′-dimethoxybenzidine, 3,3′-diaminodiphenylether, 3,4′-diaminodiphenylether, 4,4′-diaminodiphenyl ether, 3,3′-diaminodiphenyl sulfide, 3,4′-diaminodiphenyl sulfide, 4,4′-diaminodiphenyl sulfide, 3,3′-diaminodiphenylsulfone, 3,4′-diaminodiphenylsulfone, 4,4′-diaminodiphenylsulfone, 3,3′-diaminobenzophenone, 4,4′-diaminobenzophenone, 3,3′-diamino-4,4′-dichlorobenzophenone, 3,3′-diamino-4,4′-dimethoxybenzophenone, 3,3′-diaminodiphenylmethane, 3,4′-diaminodiphenylmethane, 4,4′-diaminodiphenylmethane, 2,2-bis(3-aminophenyl)propane, 2,2-bis(4-aminophenyl)propane, 2,2-bis(3-aminophenyl)-1,1,1,3,3,3-hexafluoropropane, 2,2-bis(4-aminophenyl)-1,1,1,3,3,3-hexafluoropropane, 3,3′-diaminodiphenyl sulfoxide, 3,4′-diaminodiphenylsulfoxide, 4,4′-diaminodiphenylsulfoxide, 1,3-bis(3-aminophenyl)benzene, 1,3-bis(4-aminophenyl)benzene, 1,4-bis(3-aminophenyl)benzene, 1,4-bis(4-aminophenyl)benzene, 1,3-bis(4-aminophenoxy)benzene (TPE-R), 1,4-bis(3-aminophenoxy)benzene (TPE-Q), 1,3-bis(3-aminophenoxy)-4-trifluoromethylbenzene, 3,3′-diamino-4-(4-phenyl)phenoxybenzophenone, 3,3′-diamino-4,4′-di(4-phenylphenoxy)benzophenone, 1,3-bis(3-aminophenylsulfide)benzene, 1,3-bis(4-aminophenylsulfide)benzene, 1,4-bis(4-aminophenylsulfide)benzene, 1,3-bis(3-aminophenylsulfone)benzene, 1,3-bis(4-aminophenylsulfone)benzene, 1,4-bis(4-aminophenylsulfone)benzene, 1,3-bis[2-(4-aminophenyl)isopropyl]benzene, 1,4-bis[2-(3-aminophenyl) isopropyl]benzene, 1,4-bis[2-(4-aminophenyl)isopropyl]benzene, 3,3′-bis(3-aminophenoxy) biphenyl, 3,3′-bis(4-aminophenoxy) biphenyl, 4,4′-bis(3-aminophenoxy) biphenyl, 4,4′-bis(4-aminophenoxy) biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, bis[3-(3-aminophenoxy)phenyl]ketone, bis[3-(4-aminophenoxy)phenyl]ketone, bis[4-(3-aminophenoxy)phenyl]ketone, bis[4-(4-aminophenoxy)phenyl]ketone, bis[3-(3-aminophenoxy)phenyl]sulfide, bis[3-(4-aminophenoxy)phenyl]sulfide, bis[4-(3-aminophenoxy)phenyl]sulfide, bis[4-(4-aminophenoxy)phenyl]sulfide, bis[3-(3-aminophenoxy))phenyl]sulfone, bis[3-(4-aminophenoxy)phenyl]sulfone, bis[4-(3-aminophenoxy)phenyl]sulfone, bis[4-(4-aminophenoxy)phenyl]sulfone, bis[3-(3-aminophenoxy)phenyl]methane, bis[3-(4-aminophenoxy)phenyl]methane, bis[4-(3-aminophenoxy)phenyl]methane, bis[4-(4-aminophenoxy)phenyl]methane, 2,2-bis[3-(3-aminophenoxy)phenyl]propane, 2,2-bis[3-(4-aminophenoxy)phenyl]propane, 2,2-bis[4-(3-amino) phenoxy)phenyl]propane, 2,2-bis[4-(4-aminophenoxy)phenyl]propane (BAPP), 2,2-bis[3-(3-aminophenoxy)phenyl]-1,1,1,3,3,3-hexafluoropropane, 2,2-bis[3-(4-aminophenoxy)phenyl]-1,1,1,3,3,3-hexafluoropropane, 2,2-bis[4-(3-aminophenoxy)phenyl]-1,1,1,3,3,3-hexafluoropropane, and 2,2-bis[4-(4-aminophenoxy)phenyl]-1,1,1,3,3,3-hexafluoropropane.

11. The manufacturing method of claim 1, further comprising:
(c) washing, filtering, and drying the polyimide powder.

12. The manufacturing method of claim 1, wherein in the imidizing, an imidization rate is 97 to 100%.

13. Polyimide powder manufactured according to the manufacturing method of polyimide powder according to claim 1.

14. The polyimide powder of claim 13, wherein the polyimide powder has an intrinsic viscosity of 1.0 to 1.5 dL/g.

15. A polyimide molded article comprising the polyimide powder according to claim 13.

16. (canceled)

17. (canceled)

18. The manufacturing method of claim 1, wherein in step (b), a solid content of the polyimide powder is 1 to 25% by weight.

19. The polyimide molded article of claim 15, wherein the polyimide molded article has a tensile strength of 85 MPa or more.

20. The polyimide molded article of claim 15, wherein the polyimide molded article has an elongation of 7% or more.

21. They polyimide molded article of claim 15, wherein the polyimide molded article has a modulus of 1.5 GPa or more.

22. The polyimide molded article of claim 15, wherein the polyimide molded article has a flexural strength of 150 Mpa or more.
